(19) United States
(12) Patent Application Publication
(10) Pub. No.: US 2025/0325042 A1
(43) Pub. Date: Oct. 23, 2025

(54) MULTI-FUNCTIONAL HANDHELD DEVICE WITH AN ADJUSTABLE SMOKING PRODUCT HOLDER

(71) Applicant: Robert Julio Rivera, Brooklyn, NY (US)

(72) Inventor: Robert Julio Rivera, Brooklyn, NY (US)

(21) Appl. No.: 18/642,670

(22) Filed: Apr. 22, 2024

(51) Int. Cl. A24F 40/60; A24F 7/00; A24F 13/12; A24F 40/20; A24F 40/40; A24F 40/51; A24F 40/65; A24F 40/90; G06F 3/16

(52) U.S. Cl. CPC A24F 40/60; A24F 7/00; A24F 13/12; A24F 40/20; A24F 40/40; A24F 40/51; A24F 40/65; A24F 40/90; G06F 3/165

(57) ABSTRACT

The present invention relates a multi-functional handheld device incorporating an adjustable attachment for accommodating different sized smoking products, and an integrated music play system with user-selectable activation options. The multi-functional handheld device comprises a housing, an adjustable holder, a mouthpiece, and the music play system. The multi-functional handheld device provides a compact design that allows for easy carrying and use. The adjustable attachment of the multi-functional handheld device accommodates various smoking products, and the music play system of the multi-functional handheld device provides entertainment options. The multi-functional handheld device provides multiple ways to activate the music play system for enhancing user experience.

### FIELD OF THE INVENTION

The present disclosure relates generally to multi-functional handheld devices, and more particularly to a multi-functional handheld device incorporating an adjustable attachment for accommodating different sized smoking products, and an integrated music play system with user-selectable activation options.

### BACKGROUND

Smoking products, such as cigarettes and marijuana cones, are a prevalent part of many cultures and daily routines. These products require dedicated devices, such as pipes, bongs, or cigarette holders for holding and consuming them. However, traditional smoking devices are typically single-purpose and lack additional functionalities that could enhance the user experience.

In the case of cigarette smoking, there is a growing desire among users to engage in concurrent activities while consuming the product. Listening to music is a popular choice, as it can provide relaxation, enjoyment, or simply background noise. However, using separate devices for smoking and music playback can be inconvenient and cumbersome. Traditional cigarette holders offer no music functionality, and portable music players often require two hands to operate. This creates a juggling act for the user, who must hold the cigarette, control playback functions, and potentially manage additional tasks like lighting up or adjusting volume.

Existing portable music players are even designed for one-handed operation, they often lack features specifically designed for smokers. The controls might be too small or require precise manipulation, making them difficult to use while holding the cigarette. Additionally, these players are typically not built with durability or portability for situations where a user might be walking, socializing, or engaging in outdoor activities while smoking. Carrying and managing separate devices for smoking and music playback can be a hassle, especially during activities that require mobility or focus. Users might need to juggle the devices between their hands, clip them to clothing, or set them down on surfaces where they could be misplaced or damaged.

Furthermore, the act of lighting a cigarette and holding a separate music play system can be awkward and impractical. The user may need to set down the music play system to free a hand for lighting, which potentially exposes the music play system to damage or loss if fumbled or placed on an uneven surface. This interruption in the music playback can also be disruptive to the user's experience. Additionally, the act of holding both a cigarette and a music play system can be uncomfortable for extended periods, which potentially leads to hand strain or fatigue.

Beyond cigarettes, marijuana use is becoming increasingly legalized and recreational, with a growing number of users consuming the product for medicinal or recreational purposes. Similar to cigarette smokers, cannabis users often enjoy listening to music while consuming the product. However, existing smoking devices for marijuana, such as pipes and bongs, are even less conducive to multitasking with activities like music playback. These devices are often bulky and awkward to hold, which makes it difficult to manage both the smoking device and a separate music play system simultaneously.

While some combination products exist, such as lighters with built-in speakers, these solutions typically offer limited functionality. The speakers in these lighters are often small and cheaply made, which results in low-quality sound that is inadequate for an enjoyable music listening experience. Additionally, the integration of the speaker into the lighter can be bulky or poorly designed, which makes the overall device awkward to hold and use. These combination products often prioritize the lighter function, with the music playback being a secondary and poorly implemented feature.

In the absence of a dedicated solution, some smokers resort to using smartphone apps for music playback. However, smartphone use while smoking can be cumbersome and distracting. Smartphones are not designed for single-handed operation while holding a smoking product, and the act of repeatedly taking a phone out and putting it down during a smoking session can disrupt the user's flow and increase the risk of dropping or damaging the smartphone. Additionally, smartphone batteries can drain quickly when used for music playback, and the constant notifications and distractions associated with smartphones can detract from the user's smoking experience.

By addressing all the above-mentioned limitations, there is a need for a multi-functional handheld device that incorporates with an adjustable attachment for accommodating different sized smoking products, and an integrated music play system with user-selectable activation options. There is also a need for a multi-functional handheld device that offers features specifically designed for smokers, such as a comfortable grip that can accommodate both the smoking product and the device itself. Further, there is also a need for a multi-functional handheld device that provides a more streamlined and enjoyable experience for users who enjoy smoking and listening to music concurrently by eliminating the need to manage separate devices,

### SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key nor critical elements of all embodiments, nor delineate the scope of any or all embodiments.

The present disclosure, in one or more embodiments, relates to a multi-functional handheld device incorporating an adjustable attachment for accommodating different sized smoking products, and an integrated music play system with user-selectable activation options. The multi-functional handheld device with an adjustable smoking product holder comprises a housing, an adjustable holder, a mouthpiece, and a music play system.

In one embodiment herein, the housing is defining a chamber. In one embodiment herein, the adjustable holder is extended outwardly from at least one side portion of the housing. The adjustable holder is configured to secure at least one smoking product for consuming by a user. The adjustable holder is configured to facilitate the user to secure the smoking product having various sizes and shapes.

In one embodiment herein, the mouthpiece is extended outwardly from the housing and opposite to the adjustable holder. The mouthpiece is fluidly connected to the adjustable holder through a channel, thereby allowing the user to consume the smoking product. In one embodiment herein, the music play system is operably disposed within the chamber of the housing. The music play system is configured to output plurality of audio files stored in a memory unit upon actuation by the user through a control switch. The music play system is at least one of a self-contained media player, an audio player, a music play device, and a music player.

In one embodiment herein, the multi-functional handheld device comprises a power switch, at least one sensor and a controller. In one embodiment herein, the power switch is configured to turn on and turn off the music player. In one embodiment herein, the controller is configured to control an operation of the music play system upon actuation by the user through the control switch and the power switch, thereby playing the plurality of audio files through a speaker of the multi-functional handheld device.

The controller is further configured to receive the output signals from the at least one sensor and actuate the music play system in response to the detection of the user's contact and the suction action while consuming the smoking product. In one embodiment herein, the at least one sensor is configured to detect a user's contact and a suction action while consuming the smoking product. The at least one sensor is positioned within the mouthpiece. The at least one sensor is configured to transfer output signals to the controller.

In one embodiment herein, the multi-functional handheld device comprises a wireless transceiver, at least one power source, and at least one charging port. In one embodiment herein, the wireless transceiver is in communication with the controller. The wireless transceiver is configured to enable a communication with at least one of a computing device and a music streaming device via a network for receiving the one or more audio files and playing through the speaker of the multi-functional handheld device. In one embodiment herein, the at least one power source is configured to provide electrical power for operating the music player. In one embodiment herein, the at least one charging port is configured to facilitate the user to recharge the at least one power source of the multi-functional handheld device.

In one embodiment herein, the multi-functional handheld device with an adjustable smoking product holder comprises a housing, an adjustable holder, a mouthpiece, a music play system, at least one sensor and a controller. In one embodiment herein, the housing is defining a chamber. In one embodiment herein, the adjustable holder is extended outwardly from at least one side portion of the housing. The adjustable holder is configured to secure at least one smoking product for consuming by the user.

In one embodiment herein, the mouthpiece is extended outwardly from the housing and opposite to the adjustable holder. The mouthpiece is fluidly connected to the adjustable holder through a channel, thereby allowing the user to consume the smoking product. In one embodiment herein, the music play system is operably disposed within the chamber of the housing. The music play system is configured to output plurality of audio files stored in a memory unit upon actuation.

In one embodiment herein, the at least one sensor is configured to detect a user's contact and a suction action while consuming the smoking product and transfer output signals. In one embodiment herein, the controller is configured to control an operation of the music play system upon actuation by the user through the power switch and based on the output signals received from the at least one sensor, thereby actuating the music play system to play the plurality of audio files through a speaker in response to the detection of the user's contact and the suction action while consuming the smoking product.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates an isometric view of a multi-functional handheld device, in accordance with embodiments of the invention.

FIG. 2A illustrates a top perspective view of the multi-functional handheld device, in accordance with embodiments of the invention.

FIG. 2B illustrates a bottom perspective view of the multi-functional handheld device, in accordance with embodiments of the invention.

FIG. 3 illustrates a block diagram of the multi-functional handheld device in communication with a computing device, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

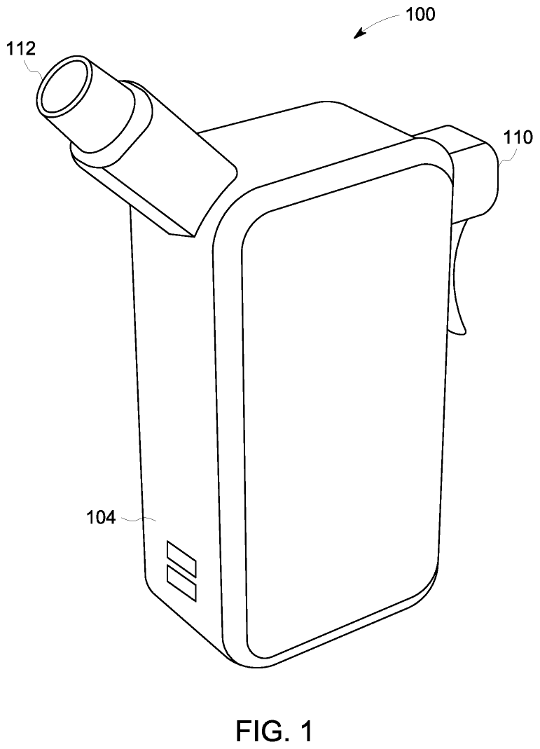

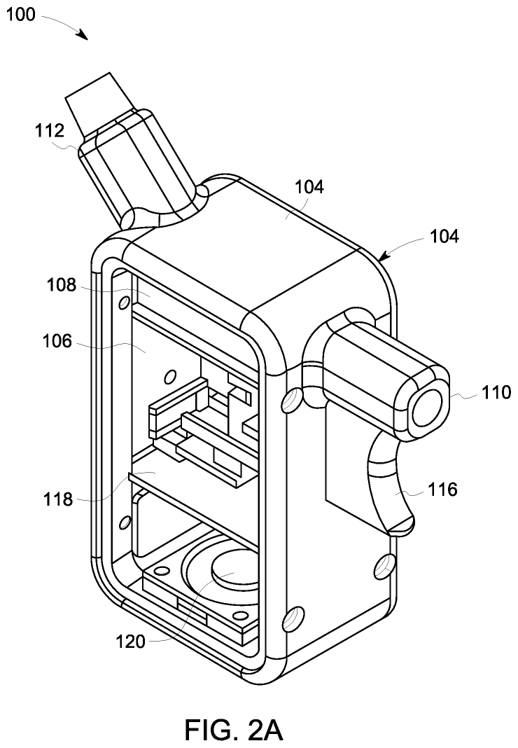

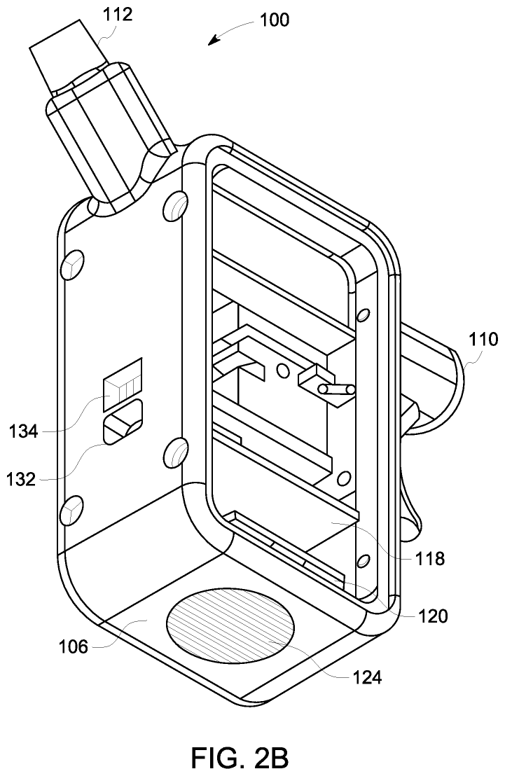

FIG. 1 refers to an isometric top view of a multi-functional handheld device 100. In one embodiment herein, the multi-functional handheld device 100 comprises a housing 104 defining a chamber 106 (shown in FIG. 2A), which encases all the internal components. The housing 104 is typically made from a durable and lightweight material such as, but not limited to, plastic and metal. In one embodiment herein, the housing 104 of the multi-functional handheld device 100 is in a rectangular-shaped configuration. This rectangular design provides a comfortable grip for users to hold the multi-functional handheld device 100 and allows for efficient placement of the internal components. In other embodiments, the housing 104 may potentially be adapted to other shapes, such as square, cylindrical, triangular, and etc.

In one embodiment herein, the multi-functional handheld device 100 also comprises an adjustable holder 110, and a mouthpiece 112. The adjustable holder 110 is extended outwardly at least one side portion of the housing 104. The primary function of the adjustable holder 110 is to securely hold at least one smoking product for consumption by a user. The smoking product can be, but not limited to, cigarettes, cigars, and marijuana cones, thereby providing the user with a range of options to choose multiple smoking products. The adjustable holder 110 is configured to facilitate the user to secure the smoking product having various sizes and shapes. The adjustable holder 110 is configured to be adjusted to ensure that the smoking product fits snugly and securely within it and may provide different levels of support to ensuring stability and optimal use, thereby ensuring stability and safety for the user during smoking.

FIG. 2A refers to a perspective top view of the multi-functional handheld device 100. In one embodiment herein, the mouthpiece 112 is extended outwardly from the housing 104 and opposite to the adjustable holder 110. The mouthpiece 112 is fluidly connected to the adjustable holder 110 through a channel 108. The mouthpiece 112 is configured to allow the user to inhale smoke from the smoking product placed into the adjustable holder 110. The mouthpiece 112 can be made from a heat-resistant and comfortable material such as, but not limited to, silicone or plastic. The mouthpiece 112 can be ergonomically designed to fit comfortably on the user's lips, thereby ensuring proper smoke inhalation and preventing any heat-related injuries and discomfort for the user during extended use. In some embodiments herein, the mouthpiece 112 may comprise additional features like filters or cooling mechanisms to enhance the user experience. The mouthpiece 112 provides a natural smoking experience and enhances the flavor and quality of the smoke for the user without causing any chafing or irritation.

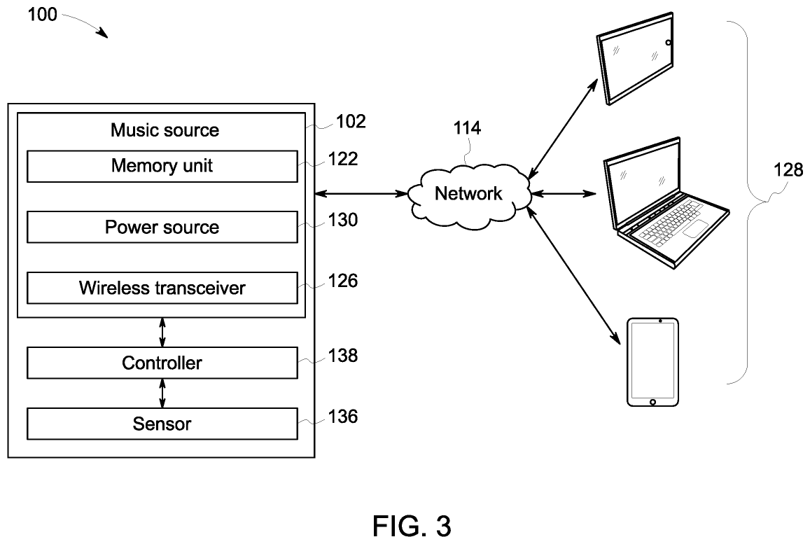

FIG. 2B refers to a perspective bottom view of the multi-functional handheld device 100. In one embodiment herein, the music play system 102 (shown in FIG. 3) comprises a soundboard 118 that is operably disposed within the chamber 106 of the housing 104. The soundboard 118 may include a digital-to-analog converter (DAC) that transforms the digital audio files into an analog signal. In one embodiment herein, the multi-functional handheld device 100 further comprises a speaker 120 for providing audible sounds that can be heard by the user upon actuation of the music play system 102. In one embodiment herein, the speaker 120 is located at the bottom of the housing 104 for allowing the audible sound to project downwards, which potentially minimizes any obstruction by the user's hand while holding the multi-functional handheld device 100. The speaker 120 offers better and more accurate audible sounds with a more immersive and enjoyable listening experience.

In one embodiment herein, a protective cover 124 is positioned on the base 106 of the housing 104 to protect the speaker 120 from dust, debris, or accidental damage. The protective cover 124 could be a speaker grill. This protective cover 124 allows a clear audio output while safeguarding the speaker 120. The protective cover 124 is usually made of a perforated material such as metal and plastic, which allows audible sound waves to pass through while blocking solid objects or dust particles. In some embodiment herein, the protective cover 124 can be customized with different designs such as patterns, logos, or graphics to match the speaker's overall design. In one embodiment herein, the multi-functional handheld device 100 comprises a power switch 134 that is conveniently positioned on the housing 104 for easy user access. The user is allowed to turn on and turn off the music play system 102 easily upon pressing the power switch 134.

FIG. 3 refers to a block diagram of the multi-functional handheld device 100 in communication with a computing device 128. The music play system 102 is configured to output the audio files stored in a memory unit 122 upon actuation by the user through a control switch 116 (shown in FIG. 2A). In one embodiment described herein, the music play system 102 is at least one of a self-contained media player, an audio player, a music playback device, and a music player. The audio files include a variety of music genres and pre-recorded sounds, such as songs, nature sounds, calming tones, or even humorous sound effects, which enhance the user's experience. The audio files are likely stored in a memory unit 122 within the multi-functional handheld device 100. In one embodiment herein, the memory unit 122 can be, but not limited to, a flash memory, a solid-state drive (SSD), and thereof.

In one embodiment herein, the multi-functional handheld device 100 also comprises a wireless transceiver 126 in communication with the controller 138 configured to enable a communication between the music paly system 102 and at least one of a computing device 128 through a network 114 for receiving the audio files and playing through the speaker 120 of the multi-functional handheld device 100. The network 114 could be, but not limited to, Bluetooth, Wi-Fi, and similar wireless protocols to establish a connection between the music play system 102 and the computing device 128. In one embodiment herein, the computing device 128 can be, but not limited to, a smartphone, a computer, a laptop, a personal digital assistant (PDA), and a tablet, etc. Once connected, the user can stream their own music collection stored on their computing device 128, thereby providing significant flexibility and personalization compared to relying solely on the pre-loaded audio files in the memory unit 122. The users can enjoy their favourite music choices or tailor the audio experience according to their mood while consuming the smoking product.

In one embodiment herein, the multi-functional handheld device 100 further comprises a power source 130, which is configured to supply necessary electrical power for the operation of the music play system 102. The power source 130 can be a rechargeable battery, for example, a lithium ion battery, which is integrated within the housing 104. The power source 130 allows for convenient and repeated use without the need for constantly replacing disposable batteries. The power source 130 can be conveniently recharged through a charging port 132 that is located on the housing 104 of the multi-functional handheld device 100.

In another embodiment, the multi-functional handheld device 100 may also comprise a sensor 136, which is positioned within the mouthpiece 112. The sensor 136 can be, but not limited to, a pressure sensor and an airflow sensor. The sensor 136 is configured to detect the user's contact and a suction action while consuming the smoking product. In one embodiment herein, the sensor 136 transmits an output signal to a controller 138 for actuating the music play system 102 to play the audio files through the speaker 120 in response to the detection of the user's contact and the suction action while consuming the smoking product. This innovative feature provides a convenient and intuitive way for the user to initiate music playback without the need for manual pressing of the power button 134.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A multi-functional handheld device with an adjustable smoking product holder, comprising:
a housing defining a chamber;
an adjustable holder extended outwardly from at least one side portion of said housing, wherein said adjustable holder is configured to secure at least one smoking product for consuming by a user;
a mouthpiece extended outwardly from said housing and opposite to said adjustable holder, wherein said mouthpiece is fluidly connected to said adjustable holder through a channel, thereby allowing the user to consume the smoking product; and
a music play system operably disposed within said chamber of the housing, wherein said music play system is configured to output a plurality of audio files stored in a memory unit upon actuation by the user through a control switch.

2. The multi-functional handheld device of claim 1, wherein the adjustable holder is configured to facilitate the user to secure the smoking product having various sizes and shapes.

3. The multi-functional handheld device of claim 1, wherein the multi-functional handheld device comprises a power switch configured to turn on and turn off said music player.

4. The multi-functional handheld device of claim 1, wherein the multi-functional handheld device comprises:
a controller configured to control an operation of said music play system upon actuation by the user through the control switch and the power switch, thereby playing the plurality of audio files through a speaker of said multi-functional handheld device.

5. The multi-functional handheld device of claim 1, wherein the multi-functional handheld device comprises at least one sensor configured to detect a user's contact and a suction action while consuming the smoking product.

6. The multi-functional handheld device of claim 5, wherein the at least one sensor is positioned within said mouthpiece.

7. The multi-functional handheld device of claim 5, wherein the at least one sensor is configured to transfer output signals to said controller.

8. The multi-functional handheld device of claim 4, wherein the controller is further configured to receive the output signals from said at least one sensor and actuate said music play system in response to the detection of the user's contact and the suction action while consuming the smoking product.

9. The multi-functional handheld device of claim 1, wherein the multi-functional handheld device comprises:
a wireless transceiver in communication with said controller configured to enable a communication with at least one of a computing device and a music streaming device via a network for receiving the one or more audio files and playing through said speaker of said multi-functional handheld device;
a soundboard operably disposed within the chamber of the housing, wherein the soundboard includes a digital-to-analog converter (DAC) that transforms digital audio files into an analog signal; and
at least one power source configured to provide electrical power for operating said music player.

10. The multi-functional handheld device of claim 1, wherein the multi-functional handheld device comprises:
at least one charging port configured to facilitate the user to recharge the at least one power source of the multi-functional handheld device.

11. The multi-functional handheld device of claim 1, wherein the music play system is at least one of a self-contained media player, an audio player, a music play device, and a music player.

12. A multi-functional handheld device with an adjustable smoking product holder, comprising:
a housing defining a chamber;
an adjustable holder extended outwardly from at least one side portion of said housing, wherein said adjustable holder is configured to secure at least one smoking product for consuming by a user;
a mouthpiece extended outwardly from said housing and opposite to said adjustable holder, wherein said mouthpiece is fluidly connected to said adjustable holder through a channel, thereby allowing the user to consume the smoking product;
a music play system operably disposed within said chamber of the housing, wherein said music play system is configured to output plurality of audio files stored in a memory unit upon actuation;
at least one sensor configured to detect a user's contact and a suction action while consuming the smoking product and transfer output signals; and
a controller configured to control an operation of said music play system upon actuation by the user through the power switch and based on the output signals received from said at least one sensor, thereby actuating said music play system to play the plurality of audio files through a speaker in response to the detection of the user's contact and the suction action while consuming the smoking product.

13. The multi-functional handheld device of claim 12, wherein the adjustable holder is configured to facilitate the user to secure the smoking product having various sizes and shapes.

14. The multi-functional handheld device of claim 12, wherein the multi-functional handheld device comprises a power switch configured to turn on and turn off said music player.

15. The multi-functional handheld device of claim 12, wherein the at least one sensor is positioned within said mouthpiece.

16. The multi-functional handheld device of claim 12, wherein the multi-functional handheld device comprises:
a wireless transceiver in communication with said controller configured to enable a communication with at least one of a computing device and a music streaming device via a network for receiving the one or more audio files and playing through said speaker of said multi-functional handheld device; and
at least one power source configured to provide electrical power for operating said music player.

17. The multi-functional handheld device of claim 12, wherein the multi-functional handheld device comprises:
at least one charging port configure to facilitate the user to recharge the at least one power source of the multi-functional handheld device.

18. The multi-functional handheld device of claim 12, wherein the music play system is at least one of a self-contained media player, an audio player, a music play device, and a music player.
